(19) United States
(12) Patent Application Publication
(10) Pub. No.: US 2012/0112097 A1
(43) Pub. Date: May 10, 2012

(54) METHOD AND APPARATUS FOR QUANTITATIVE ANALYSIS OF THE EXTENT OF MEMBRANE FOULING BY USING FLUORESCENT PROTEIN STRUCTURES

(75) Inventors: Young Haeng LEE, Seoul (KR); Jae Hoon KIM, Seoul (KR); Jong Soo JURNG, Seoul (KR); Yang Soo HAN, Yongin-si (KR)

(73) Assignee: KOREA INSTITUTE OF SCIENCE AND TECHNOLOGY, Seoul (KR)

(21) Appl. No.: 13/018,958

(22) Filed: Feb. 1, 2011

(30) Foreign Application Priority Data
Nov. 10, 2010 (KR) 10-2010-0111475

(51) Int. Cl. G01N 21/64

(52) U.S. Cl. 250/459.1; 250/458.1

(57) ABSTRACT

Disclosed are a method and an apparatus for quantitative analysis of the extent of separation membrane fouling using a fluorescent protein structure, allowing easy quantitative analysis of the extent of separation membrane fouling and improving accuracy thereof. The disclosed method for quantitative analysis of the extent of separation membrane fouling using a fluorescent protein structure includes: preparing a solution containing a fluorescent protein structure; passing the solution containing the fluorescent protein structure through a separation membrane so as to adsorb the fluorescent protein structure onto the separation membrane; and quantitatively analyzing the fluorescent protein structure adsorbed onto the separation membrane by measuring fluorescence emitted by the fluorescent protein structure adsorbed to the separation membrane.

### CROSS-REFERENCE TO RELATED APPLICATION

This application claims priority to Korean Patent Application No. 10-2010-0111475, filed on Nov. 10, 2010, and all the benefits accruing therefrom under 35 U.S.C. §119, the contents of which in its entirety are herein incorporated by reference.

### BACKGROUND

1. Field

The present disclosure relates to a method and an apparatus for quantitative analysis of the extent of separation membrane fouling using a fluorescent protein structure. More particularly, the disclosure relates to a method and an apparatus for quantitative analysis of the extent of separation membrane fouling using a fluorescent protein structure, allowing easy quantitative analysis of the extent of separation membrane fouling and improving accuracy thereof.

2. Description of the Related Art

Separation membranes are widely used for a variety of water treating processes. After prolonged use, the separation membrane is contaminated by proteins, microorganisms or other membrane-fouling materials, resulting in decreased treatment capacity. Thus, the separation membrane needs to be periodically cleaned or replaced.

Accordingly, development of anti-fouling separation membranes to reduce the contamination of the separation membranes is important in the related industry. Also, a convenient and accurate method for quantitative analysis of the extent of separation membrane fouling is very important.

As described, the materials that contaminate the separation membrane include water-soluble proteins and particulate microorganisms. Among them, proteins are typically analyzed by extraction from the separation membrane followed by concentration measurement.

However, the method of extracting proteins directly from the fouled separation membrane and then measuring the extent of fouling is inaccurate because the recovery of the proteins adsorbed on the fouled separation membrane is very low.

### SUMMARY

The present disclosure is directed to providing a method and an apparatus for quantitative analysis of the extent of separation membrane fouling using a fluorescent protein structure, allowing easy quantitative analysis of the extent of separation membrane fouling and improving accuracy thereof.

In one aspect, there is provided a method for quantitative analysis of the extent of separation membrane fouling using a fluorescent protein structure, including: preparing a solution containing a fluorescent protein structure; passing the solution containing the fluorescent protein structure through a separation membrane so as to adsorb the fluorescent protein structure onto the separation membrane; and quantitatively analyzing the fluorescent protein structure adsorbed onto the separation membrane by measuring fluorescence emitted by the fluorescent protein structure adsorbed to the separation membrane.

The fluorescent protein structure may consist of a standard protein actually adsorbed to the separation membrane and a fluorescent protein binding with the standard protein and emitting fluorescence. The standard protein may be albumin, and the fluorescent protein may be at least one selected from a group consisting of green fluorescent protein (GFP), enhanced GFP (EGFP), enhanced yellow fluorescent protein (EYFP), mCitrine, Venus, monomeric enhanced cyan fluorescent protein (mECFP), Cerulean, enhanced blue fluorescent protein (EBFP), Azurite, DSRed, mOrange, mStrawberry, mCherry and combinations thereof. The fluorescence may be recognized by a fluorescence microscope, a fluorescence spectrophotometer, a fluorescence detector or a fluorescence sensor.

In another aspect, there is provided an apparatus for quantitative analysis of the extent of separation membrane fouling using a fluorescent protein structure, including: a separation membrane; a separation membrane filtering device passing a solution containing a fluorescent protein structure through the separation membrane so as to adsorb the fluorescent protein structure onto the separation membrane; and a fluorescence recognizing device quantitatively analyzing the fluorescent protein structure adsorbed onto the separation membrane by recognizing fluorescence emitted by the fluorescent protein structure.

### DETAILED DESCRIPTION

Exemplary embodiments now will be described more fully hereinafter. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced items. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skills in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The method for quantitative analysis of the extent of separation membrane fouling using a fluorescent protein structure according to the present disclosure comprises: adsorbing a fluorescent protein structure onto a separation membrane; and quantitatively analyzing the fluorescent protein structure adsorbed onto the separation membrane using a fluorescence recognizing device.

The fluorescent protein structure comprises a standard protein and a fluorescent protein. The standard protein is actually adsorbed to the separation membrane, and the fluorescent protein binds with the standard protein and emits fluorescence, thus being recognized by the fluorescence recognizing device. The fluorescence recognizing device may be a fluorescence microscope, a fluorescence spectrophotometer, a fluorescence detector or a fluorescence sensor.

The standard protein may be albumin. Particularly, the standard protein may be bovine serum albumin(BSA). And the fluorescent protein may be at least one selected from a group consisting of green fluorescent protein (GFP), enhanced GFP (EGFP), enhanced yellow fluorescent protein (EYFP), mCitrine, Venus, monomeric enhanced cyan fluorescent protein (mECFP), Cerulean, enhanced blue fluorescent protein (EBFP), Azurite, DSRed, mOrange, mStrawberry, mCherry and combinations thereof.

### EXAMPLE

The method and the apparatus for quantitative analysis of the extent of separation membrane fouling using a fluorescent protein structure according to the present disclosure will be described in detail through an example.

<Example>

Four circular-shaped (diameter 1.8 cm) separation membranes (separation membranes A, B, C and D) made of different materials were prepared. For determination of intrinsic resistance Rₘ of each separation membrane, ultrapure water with 0.1 M phosphate buffer solution (PBS) added was passed through the separation membrane. Then, for quantitative evaluation of the extent of separation membrane fouling by means of fluorescent protein and for determination of total resistance Rₜ of each separation membrane, 100 mL of a 20 mg/L solution of a fluorescent protein structure (GFP-BSA) comprising BSA as standard protein and GFP as fluorescent protein with 0.1 M PBS added was passed through the separation membrane. A dead-end filtration device based on pressure difference was used as a separation membrane filtering device. Passing of the ultrapure water and the fluorescent protein structure solution was carried out with the separation membrane fixed by the filter holder of the separation membrane filtering device.

The intrinsic resistance Rₘ and the total resistance Rₜ of the separation membrane was calculated according to the resistance in series model (see Equation 1), and the fouling resistance R_{f} of the separation membrane was calculated from the intrinsic resistance Rₘ and the total resistance Rₜ of the separation membrane (see Equation 3).

The fouling resistance R_{f} of the separation membrane was calculated to verify the quantitative analysis result based on the measurement of fluorescence emitted by the fluorescent protein structure. Since a separation membrane with higher fouling resistance R_{f} exhibits a stronger fluorescence intensity, the reliability of the quantitative analysis can be estimated by comparing the fouling resistance and the fluorescence intensity from experiments for a plurality of separation membranes.

J=ΔP/(μ×R) <Equation 1>

In Equation 1, J is the flux through the membrane, ΔP is the transmembrane pressure, μ is the viscosity of the fluid being filtered, and R is the membrane resistance. The flux through the membrane J is calculated from Equation 2.

Flux through the membrane (J)=Volume of the fluid being filtered/(Area of the separation membrane×Time of the fluid being filtered) <Equation 2>

Total resistance Rₜ of the separation membrane=Intrinsic resistance Rₘ of the separation membrane+Fouling resistance R_{f} of the separation membrane <Equation 3>

After the passing of the solution containing the fluorescent protein structure through the separation membrane, the separation membrane contaminated by the fluorescent protein structure was separated from the filter holder and fixed with a cover slip on a glass slide. Then, fluorescence emitted from the fluorescent protein structure adsorbed onto the separation membrane was detected using a fluorescence microscope.

For quantification of the extent of separation membrane fouling by the fluorescent protein structure, the area of the separation membrane was measured. The ImageJ software was used for analysis.

For comparison of convenience and accuracy of the method for quantitative analysis of the extent of separation membrane fouling using a fluorescent protein structure according to the present disclosure, the commonly employed method of extracting the protein from the separation membrane and then quantifying the concentration of the protein was also carried out.

First, four separation membranes (separation membranes a, b, c and d) made of different materials were prepared. Then, 1000 mL of a solution with 100 mg/L of a protein (BSA) and 0.1 M PBS added was passed through the separation membrane. The same separation membrane filtering device as above was used. Subsequently, the protein was extracted from the separation membrane and the quantity of the protein was measured as follows.

The separation membrane fouled by the protein was separated from the filter holder of the separation membrane filtering device and placed in a microtube containing 2 mL of a sterilized PBS solution. Then, the protein adsorbed to the separation membrane was detached using a 20 kHz ultrasonicator. The ultrasonicator was operated for 10 minutes, and the experiment was carried out with the microtube seated on ice.

The amount of the detached protein was quantified by the Bradford assay, a widely known protein analysis technique based on protein-dye binding. Specifically, a solution of the detached protein was allowed to react with a Bradford assay solution at room temperature for 30 minutes. Then, the amount of the detached protein was quantified by measuring absorbance at 595 nm using a spectrophotometer. From the difference of the protein concentration in the solution before and after passing through the separation membrane, the maximum amount of the protein adsorbed to the separation membrane and the efficiency of detachment were calculated.

The results are as follows.

Table 1 shows the result according to the present disclosure. Fouling resistance R_{f} of the separation membrane, fluorescence emitted from the fluorescent protein and relative extent of fouling resulting from the comparison of relative extent of fouling are described.

TABLE 1
Result for the present disclosure

| | Fouling resistance | | |
|---|---|---|---|
| | R_{f} of separation | Fluorescence | Relative extent |
| | membrane (10¹⁰ m⁻¹) | intensity | of fouling (%) |
| Separation | 1.20 | 12,064,276 | 96.3 |
| membrane A | | | |
| Separation | 1.21 | 12,533,760 | 100 |
| membrane B | | | |
| Separation | 1.17 | 11,599,849 | 92.5 |
| membrane C | | | |
| Separation | 1.16 | 10,984,274 | 87.6 |
| membrane D | | | |

As seen from Table 1, the fouling resistance R_{f} was higher in the order of the separation membranes B, A, C and D. The intensity of fluorescence emitted from the fluorescent protein structure adsorbed on the contaminated separation membrane was also higher in the order of the separation membranes B, A, C and D. In Table 1, the relative extent of fouling was calculated as a % fluorescence intensity value relative to that of the separation membrane B exhibiting the highest fluorescence intensity.

Table 2 shows the result according to the related art. Fouling resistance R_{f} of the separation membrane, amount of protein detached from the separation membrane, efficiency of protein detachment and relative extent of fouling are described.

TABLE 2
Result for the related art

| | Fouling resistance | Amount of | | Relative |
|---|---|---|---|---|
| | R_{f} of separation | detached | Efficiency of | extent of |
| | membrane | protein | detachment | fouling |
| | (10¹⁰ m⁻¹) | (μg/cm²) | (%) | (%) |
| Separation | 1.56 | 0.71 | 0.078 | 76.3 |
| membrane a | | | | |
| Separation | 1.92 | 0.77 | 0.002 | 82.8 |
| membrane b | | | | |
| Separation | 1.52 | 0.73 | 0.002 | 78.5 |
| membrane c | | | | |
| Separation | 1.37 | 0.93 | 0.013 | 100 |
| membrane d | | | | |

As seen from Table 2, the fouling resistance R_{f} was higher in the order of the separation membranes b, a, c and d. However, the amount of protein detached from the separation membrane was higher in the order of the separation membranes d, b, c and a, quite differently from the tendency of the fouling resistance (b>a>c>d).

The reason why the tendency of the fouling resistance of the separation membrane is different from that of the amount of the detached protein is because the amount of protein detached from the separation membrane is very small and nonuniform, with an efficiency of detachment of 0.002-0.078%. This suggests that only a very small portion of the protein adsorbed to the contaminated separation membrane is detached and hence the reliability of the quantitative analysis of the extent of separation membrane fouling is very low in the related art.

The present disclosure is convenient in that an accurate quantitative analysis can be made with the protein adsorbed to the separation membrane. In contrast, the existing method is complicated since the protein adsorbed to the separation membrane has to be detached for quantitative analysis. Further, because the amount of the detached protein is small and nonuniform, the quantitative analysis result lacks reliability.

To summarize, the method and the apparatus for quantitative analysis of the extent of separation membrane fouling using a fluorescent protein structure provide the following advantageous effects.

Whereas the existing quantitative analysis method based on protein extraction employs detachment of only a small portion of the protein adsorbed to the separation membrane and measurement of the protein concentration, the present disclosure performs quantitative analysis conveniently and accurately by directly recognizing the protein adsorbed to the separation membrane.

In addition, whereas the existing method requires multi-step procedures and hence long time for extracting the protein and measuring the protein concentration, the present disclosure allows accurate quantitative analysis in short time since those procedures are unnecessary.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A method for quantitative analysis of the extent of separation membrane fouling using a fluorescent protein structure, comprising:
preparing a solution containing a fluorescent protein structure;
passing the solution containing the fluorescent protein structure through a separation membrane so as to adsorb the fluorescent protein structure onto the separation membrane; and
quantitatively analyzing the fluorescent protein structure adsorbed onto the separation membrane by measuring fluorescence emitted by the fluorescent protein structure adsorbed to the separation membrane.

2. The method for quantitative analysis of the extent of separation membrane fouling using a fluorescent protein structure according to claim 1, wherein the fluorescent protein structure comprises a standard protein actually adsorbed to the separation membrane and a fluorescent protein binding with the standard protein and emitting fluorescence.

3. The method for quantitative analysis of the extent of separation membrane fouling using a fluorescent protein structure according to claim 2, wherein the standard protein is albumin.

4. The method for quantitative analysis of the extent of separation membrane fouling using a fluorescent protein structure according to claim 2, wherein the fluorescent protein is at least one selected from a group consisting of green fluorescent protein (GFP), enhanced GFP (EGFP), enhanced yellow fluorescent protein (EYFP), mCitrine, Venus, monomeric enhanced cyan fluorescent protein (mECFP), Cerulean, enhanced blue fluorescent protein (EBFP), Azurite, DSRed, mOrange, mStrawberry, mCherry and combinations thereof.

5. The method for quantitative analysis of the extent of separation membrane fouling using a fluorescent protein structure according to claim 1, wherein the fluorescence is recognized by a fluorescence microscope, a fluorescence spectrophotometer, a fluorescence detector or a fluorescence sensor.

6. An apparatus for quantitative analysis of the extent of separation membrane fouling using a fluorescent protein structure, comprising:
a separation membrane;
a separation membrane filtering device passing a solution containing a fluorescent protein structure through the separation membrane so as to adsorb the fluorescent protein structure onto the separation membrane; and
a fluorescence recognizing device quantitatively analyzing the fluorescent protein structure adsorbed onto the separation membrane by recognizing fluorescence emitted by the fluorescent protein structure.

7. The apparatus for quantitative analysis of the extent of separation membrane fouling using a fluorescent protein structure according to claim 6, wherein the fluorescent protein structure comprises a standard protein actually adsorbed to the separation membrane and a fluorescent protein binding with the standard protein and emitting fluorescence.

8. The apparatus for quantitative analysis of the extent of separation membrane fouling using a fluorescent protein structure according to claim 6, wherein the fluorescence recognizing device is a fluorescence microscope, a fluorescence spectrophotometer, a fluorescence detector or a fluorescence sensor.
